(19) United States
(12) Patent Application Publication
(10) Pub. No.: US 2016/0337102 A1
(43) Pub. Date: Nov. 17, 2016

(54) Overhead information transmission method, base station, terminal and system

(71) Applicant: ZTE CORPORATION, Shenzhen, Guangdong (CN)

(72) Inventors: Yu Xin, Shenzhen (CN); Peng Hao, Shenzhen (CN); Jia Ni, Shenzhen (CN); Jun Xu, Shenzhen (CN)

(21) Appl. No.: 15/112,278

(22) PCT Filed: Jul. 31, 2014
(86) PCT No.: PCT/CN2014/083415

§ 371 Date: Jul. 18, 2016

(30) Foreign Application Priority Data
Feb. 18, 2014 (CN) 201410055538.2

(51) Int. Cl. H04L 5/00; H04W 72/04; H04W 72/08; H04W 76/04

(52) U.S. Cl. CPC H04L 5/0048; H04W 76/046; H04W 72/042; H04W 72/082; H04W 88/02

(57) ABSTRACT

Disclosed is an overhead information transmission method. The method comprises: sending, by a base station, downlink control information (DCI) to a terminal through a downlink control channel, X bits in the DCI being used for indicating M sets of downlink reference information about other terminals except the terminal, where X is a positive integer, and M is a positive integer which is less than a numerical value expressed by a downlink data processing capability parameter of the terminal. Also disclosed at the same time are a base station, a terminal and a system corresponding to the method.

### TECHNICAL FIELD

The present disclosure relates to data demodulation in the field of communications, and in particular to a method and system for transmitting overhead information, a base station (BS), and a User Equipment (UE).

### BACKGROUND

Long Term Evolution (LTE) technology applies to wireless cellular communication in Fourth Generation (4G) mobile communication technology. With a trend of increasingly dense deployment of mobile communication cells, inter-user interference becomes a major problem. At present, a number of advanced receiving algorithms have been proposed. Such advanced receiving algorithms may suppress some interference and improve demodulation performance of a receiving end. However, the advanced receiving algorithms of good interference suppression performance require acquisition of information on an interfering signal, such as information on a pilot, a Modulation and Coding Scheme (MCS), and the like.

A UE usually acquires information on an interfering signal from another user in two modes. In the first mode, the UE estimates information on the interfering signal using a blind detection algorithm. The first mode is complicated and tends to produce estimated information on the interfering signal with a certain error margin. In the second mode, a base station sends information on an interfering signal to the UE. The second mode is less complicated. The UE may acquire more accurate information on the interfering signal in the second mode. However, a drawback with the second mode is that sending the information on the interfering signal by the base station requires additional downlink overhead information. The more interfering signals there are, the more downlink overhead information will be. A focus of wireless communication system optimization is to reduce downlink overhead information.

In an LTE system, downlink overhead information is mainly sent on a downlink control channel. In order to reduce the downlink overhead information, adoption of a more advanced MCS may reduce performance of the UE in demodulating the downlink control channel. Sending the downlink overhead information on a downlink shared channel may increase a delay in acquiring the downlink overhead information by the UE. Moreover, the UE has to acquire information on the interfering signal before the UE can better demodulate data on the downlink shared channel.

Therefore, there lacks a solution for controlling an overhead for sending information on the interfering signal by a base station without impacting demodulation performance of a UE. There also lacks a solution for sending information on the interfering signal by a base station.

### SUMMARY

Embodiments herein provide a method and system for transmitting overhead information, a base station (BS), and a User Equipment (UE).

According to an embodiment herein, a method for transmitting overhead information includes:

sending, by a base station via a downlink control channel, a User Equipment (UE) Downlink Control Information (DCI), the DCI including X bits indicating M sets of downlink reference information of other UEs other than the UE.

The X is a positive integer. The M is a positive integer less than a numerical value represented by a parameter of downlink data processing capability of the UE.

According to an embodiment herein, a method for transmitting overhead information includes:

acquiring, by a User Equipment (UE) from Downlink Control Information (DCI) on a downlink control channel. N sets of downlink reference information of other UEs other than the UE.

The N is a positive integer less than a numerical value represented by a parameter of downlink data processing capability of the UE. M sets of downlink reference information of the other UEs are sent by a base station. The M is a positive integer no less than the N.

According to an embodiment herein, a base station includes a sending module configured for: sending, via a downlink control channel, a User Equipment (UE) Downlink Control Information (DCI), the DCI including X bits indicating M sets of downlink reference information of other UEs other than the UE.

The X is a positive integer. The M is a positive integer less than a numerical value represented by a parameter of downlink data processing capability of the UE.

According to an embodiment herein, a User Equipment (UE) includes an acquiring module configured for acquiring, from Downlink Control Information (DCI) on a downlink control channel. N sets of downlink reference information of other UEs other than the UE.

The N is a positive integer less than a numerical value represented by a parameter of downlink data processing capability of the UE. M sets of downlink reference information of the other UEs are sent by a base station. The M is a positive integer no less than the N.

According to an embodiment herein, a system for transmitting overhead information includes aforementioned base station and aforementioned UE.

With a method and system for transmitting overhead information, a base station (BS), and a User Equipment (UE) according to embodiments herein, after receiving a parameter of downlink data processing capability sent by a UE, a base station sends DCI to the UE via a downlink control channel, the DCI comprising X bits indicating M sets of downlink reference information of other UEs other than the UE. The X is a positive integer. The M is a positive integer less than a numerical value represented by a parameter of downlink data processing capability of the UE. According to embodiments herein, a base station slightly increases an overhead of a downlink control channel according to a parameter of downlink data processing capability fed back by a UE, such that demodulation performance of the UE may be improved. Since the UE is required to feed back the parameter of downlink data processing capability just now and then, an uplink overhead occupied by the parameter of downlink data processing capability is almost ignorable.

### BRIEF DESCRIPTION OF THE DRAWINGS

In the drawings (not necessarily to scale), like reference signs may represent like parts in different views. Like reference signs with different letter suffixes may represent different examples of like parts. The drawings generally show various embodiments discussed herein in an exemplary non-limiting way.

FIG. 1 is a flowchart of a method for transmitting overhead information according to an embodiment herein.

FIG. 2 is a diagram of interference of downlink data of other UEs according to an embodiment herein.

FIG. 3 is a diagram of a structure of a base station according to an embodiment herein,

FIG. 4 is a diagram of a structure of a UE according to an embodiment herein,

FIG. 5 is a diagram of a structure of a system for transmitting overhead information according to an embodiment herein.

### DETAILED DESCRIPTION

In an embodiment herein, after receiving a parameter of downlink data processing capability sent by a UE, a base station sends DCI to the UE via a downlink control channel, the DCI comprising X bits indicating M sets of downlink reference information of other UEs other than the UE. The X is a positive integer. The M is a positive integer less than a numerical value represented by a parameter of downlink data processing capability of the UE.

FIG. 1 is a flowchart of a method for transmitting overhead information according to an embodiment herein. As shown in FIG. 1, the method includes steps as follows.

In step 101, a base station receives a parameter of downlink data processing capability sent by a UE.

In step 102, the base station sends, via a downlink control channel, DCI to the UE. The DCI includes X bits indicating M sets of downlink reference information of other UEs other than the UE.

The X is a positive integer, The M is a positive integer less than a numerical value represented by a parameter of downlink data processing capability of the UE.

Data of the other UEs may occupy physical resources overlapping physical resources occupied by data of the UE.

The X may meet at least one of the following descriptions.

The X may be computed according to the M.

The X may vary dynamically in different Transmission Time Intervals (TTI).

The X may be no greater than a value set by a system Radio Resource Control protocol (RRC).

The X may be no greater than a value set by the system RRC according to the parameter of downlink data processing capability.

The X may be no greater than a value corresponding to the parameter of downlink data processing capability.

The parameter of downlink data processing capability may meet at least one of the following descriptions.

The parameter of downlink data processing capability may be represented by a maximal number of layers of downlink data within processing capability of the UE.

The maximal number of layers of downlink data within processing capability of the UE may be no less than a maximal number of layers of data within demodulation capability of the UE as represented by a UE Category parameter of the UE.

The parameter of downlink data processing capability may be represented by a number of degrees of freedom within processing capability of the UE.

The parameter of downlink data processing capability may be represented by a number of receiving antennae of the UE.

The parameter of downlink data processing capability may be set to the numerical value represented by the parameter of downlink data processing capability.

The parameter of downlink data processing capability may be set to the numerical value represented by the parameter of downlink data processing capability minus a maximal number of layers of data within demodulation capability of the UE as represented by a UE Category parameter of the UE.

The base station may receive the parameter of downlink data processing capability sent by the UE after sending the UE a UE Capability Enquiry.

The DCI may include an M indicating parameter. The M indicates the number of sets of downlink reference information to be sent by the base station.

The DCI may further include a parameter indicating update of the downlink reference information of the other UEs.

Each of the M sets of downlink reference information of the other UEs may include at least information on a user pilot.

The information on the user pilot may include at least a port (number) of a downlink reference signal.

When U of the M sets of downlink reference information of the other UEs belong to the other UEs served by one of other cells other than a present serving cell serving the UE, information on a user pilot in at least one of the U sets of downlink reference information may include at least information on a Cell ID of the one of the other cells where the information on the user pilot is sent. The U may be a positive integer no greater than the M.

The other cells may or may not belong to the base station.

The base station may pre-set a set containing parameters of downlink reference information of the other UEs. The base station may then select a sub-set of the set as the M sets of downlink reference information of the other UEs.

The base station may send the M sets of downlink reference information of the other UEs sequentially.

When cells serving L other UEs include a present serving cell serving the UE and other cells other than the present serving cell, the base station may first send downlink reference information of the other UEs served by the present serving cell, and then send downlink reference information of the other UEs served by the other cells.

The L may be a positive integer no greater than the M. The L other UEs may be the other UEs corresponding to the M sets of downlink reference information sent by the base station.

The base station may send the M sets of downlink reference information of the other UEs sequentially according to intensities of interference of the other UEs to the UE.

According to an embodiment herein, a method for transmitting overhead information includes steps as follows.

A UE acquires, from DCI on a downlink control channel. N sets of downlink reference information of other UEs other than the UE.

The N may be a positive integer less than a numerical value represented by a parameter of downlink data processing capability of the UE. M sets of downlink reference information of the other UEs may be sent by a base station. The M may be a positive integer no less than the N.

Data of the other UEs may occupy physical resources overlapping physical resources occupied by data of the UE.

The UE may demodulate, according to the acquired downlink reference information of the other UEs and data scheduling information acquired from a downlink control channel, data sent by the base station.

The parameter of downlink data processing capability may meet at least one of the following descriptions.

The parameter of downlink data processing capability may be represented by a maximal number of layers of downlink data within processing capability of the UE.

The maximal number of layers of downlink data within processing capability of the UE may be no less than a maximal number of layers of data within demodulation capability of the UE as represented by a UE Category parameter of the UE.

The parameter of downlink data processing capability may be represented by a number of degrees of freedom within processing capability of the UE.

The parameter of downlink data processing capability may be represented by a number of receiving antennae of the UE.

The parameter of downlink data processing capability may be set to the numerical value represented by the parameter of downlink data processing capability.

The parameter of downlink data processing capability may be set to the numerical value represented by the parameter of downlink data processing capability minus a maximal number of layers of data within demodulation capability of the UE as represented by a UE Category parameter of the UE.

The UE may send the parameter of downlink data processing capability to the base station after receiving a UE Capability Enquiry sent by the base station.

Each of the N sets of downlink reference information of the other UEs may include at least information on a user pilot.

The information on the user pilot may include at least a port of a downlink reference signal.

When demodulating the data sent by the base station, the UE may perform interference suppression according to the acquired downlink reference information of the other UEs.

The UE may detect a data signal sent by the base station according to the acquired downlink reference information of the other UEs using a Minimum Mean Square Error-Interference Rejection Combining (MMSE-IRC) advanced detection algorithm, and decode the detected data signal.

The present disclosure is elaborated below with reference to embodiments.

After acquiring information on an interfering signal, a UE may suppress some interference using an advanced receiving algorithm, improving demodulation performance of the UE. This may mean that a base station has to send the UE the information on the interfering signal, which will increase downlink overhead information. The more interfering signals there are, the more downlink overhead information will be, which may influence a downlink transmission performance.

Research shows that the UE may suppress an interfering signal to some extent; when a number of interfering signals exceeds processing capability of the UE, demodulation performance of the UE will not be improved by acquiring more information on the interfering signals.

Downlink data processing capability of the UE may be represented by a maximal number of layers of downlink data within processing capability of the UE. The maximal number of layers may depend on the number of receiving antennae of the UE. With a low correlation between the receiving antennae of the UE, the maximal number of layers may in general be the number of the receiving antennae of the UE. The maximal number of layers may also depend on the number of degrees of freedom within processing capability of the UE. Generally, the maximal number of layers may be equal to the number of degrees of freedom within processing capability of the UE.

The maximal number of layers of downlink data within processing capability of the UE (i.e., terminal) may be no less than a maximal number of layers of data within demodulation capability of the UE as represented by a UE Category parameter of the UE.

The UE may send the parameter of downlink data processing capability of the UE to the base station. The UE may send the parameter of downlink data processing capability to the base station after receiving an indication sent by the base station. The UE may send the parameter of downlink data processing capability to the base station after receiving a UE Capability Enquiry sent by the base station.

The base station may receive the parameter of downlink data processing capability sent by the UE. The base station may receive the parameter of downlink data processing capability sent by the UE after sending an indication to the UE. The base station may receive the parameter of downlink data processing capability sent by the UE after sending the UE a UE Capability Enquiry.

After acquiring the parameter of downlink data processing capability of the UE, the base station may send the UE information on other UEs (i.e., other users) having strongly interfering downlink data, and may send the UE no information on other users having but weakly interfering downlink data, such that the amount of downlink overhead information may be reduced. After obtaining the information on the other users having strongly interfering downlink data, the UE may suppress the interferences using an advanced demodulation algorithm, improving demodulation performance. Demodulation performance will not be improved much by acquiring by the UE the information on the other users having but weakly interfering downlink data. The fact that the UE acquires no information on the other users having but weakly interfering downlink data will not impact the effect of the advanced demodulation algorithm.

The other UEs having strongly interfering downlink data may refer to UEs receiving downlink data sent by the base station or other base stations strongly interfering with the data demodulation at the UE under consideration. The other UEs having but weakly interfering downlink data may refer to UEs receiving downlink data sent by the base station or other base stations barely interfering with the data demodulation at the UE under consideration. Herein, the other UEs having interfering downlink data may also be referred to as interfering UEs or interfering users.

The information on the other UEs may mainly include BS-sent downlink reference information relevant to the other UEs, such as a UE-Specific reference signal antenna port, a cell ID, etc. In an LTE system, a UE-Specific reference signal sometimes refers to a DeModulation Reference Signal (DMRS).

Having obtained the parameter of downlink data processing capability of the UE, the base station has to send information on other interfering UEs in some way or other. The base station may send information on other interfering users in DCI (also known as downlink control signalling) on the downlink control channel. In this way, the information may be conveniently received by the UE. In addition, a size of the DCI may be conveniently controlled. The base station may send the information on the other interfering users as follows.

The base station may send, on a downlink control channel, data scheduling information of the UE, and send, in DCI on a downlink control channel, the M sets of downlink reference information of the other UEs with data occupying physical resources overlapping those occupied by data of the UE. The M may be a positive integer less than the amount represented by the parameter of downlink data processing capability.

The downlink control channel bearing the data scheduling information may be in a Transmission Time Interval (TTI) identical to or different from a TTI including the downlink control channel bearing the DCI including the M sets of downlink reference information of the other UEs.

The base station may not be required to send the DCI in each TTI. That is, the base station may send no such DCI in some TTIs and send such DCI in some other TTIs.

The M sets of downlink reference information in the DCI may take up X bits. The X is a positive integer. The X may be computed according to the M. That is, a mathematical expression for computing the magnitude of the X may contain the parameter M. In other words, the size of the DCI may be computed according to the magnitude of the M. The magnitude of the X may also depend on the size of each set of information. The size of each set of information may be fixed or may vary slowly, while the M may vary quickly. The M may differ depending on different TTIs. Consequently, the magnitude of the X may vary dynamically in different TTIs. That is, the size of the DCI in one TTI may or may not be the same as the size of the DCI in another TTI.

The magnitude of the X may be set according to a value set by a system RRC, and may be no greater than the value set by the system RRC. The value set by the system RRC may be set according to the parameter of downlink data processing capability. The magnitude of the X may vary dynamically in different TTIs.

A value corresponding to the parameter of downlink data processing capability may be pre-set. The magnitude of the X may be no greater than the value corresponding to the parameter of downlink data processing capability.

A base station serving the other user(s) may be the base station or another base station. In a wireless communication system, a common base station may include one or more cells (or sectors) under its management.

A base station herein may be used to refer to a cell. For an LTE system, a base station herein may be used to refer to a cell of the LTE system. The cell serving the other user(s) may be the present serving cell serving the UE, or may be some other cell(s).

By overlapping physical resources occupied by data of the UE, it means that physical resources occupied by downlink data sent by the base station to the UE overlap physical resources occupied by downlink data sent to the other UEs by the base station under consideration or by other base stations.

The physical resources may refer to wireless physical resources, defined by positions of data in a time domain and a frequency domain during wireless transmission. For the LTE system, physical resources may be defined in terms of Resource Elements (RE).

By overlapping, it means that a base station sends data to the UE on a physical resource, while the base station under consideration or another base station sends data also to another user on the same physical resource. Data sent to different users on a same physical resource may interfere with each other.

There may be a total of L of the other UEs. The L may be a positive integer no greater than the M.

Besides the other users, data of a further user may also be transmitted on the same physical resources, which may cause relatively weak interference to the UE. Therefore, the further user may be excluded from the other users.

The DCI may also include an M indicating parameter. The M may indicate the number of sets of downlink reference information to be sent by the base station.

The DCI may also include a parameter indicating update of downlink reference information of other UEs.

Each of the M sets of downlink reference information of the other UEs may include at least information on a user pilot.

The information on the user pilot may refer to information on a downlink reference signal relevant to a user sent by the base station, such as UE-Specific reference signals for data demodulation by the user.

The information on the user pilot may include at least a port of a downlink reference signal.

When U of the M sets of downlink reference information of the other UEs belong to the other UEs served by one of other cells other than a present serving cell serving the UE, information on a user pilot in at least one of the U sets of downlink reference information may include at least information on a Cell ID of the one of the other cells where the information on the user pilot is sent. The U may be a positive integer no greater than the M. If both the UE and one of the other UEs are served by the present serving cell, information on a pilot for the one of the other UEs may include no information on the Cell ID of the present serving cell.

The base station may pre-set a set containing parameters of downlink reference information of the other UEs. The base station may select a sub-set of the set as the M sets of downlink reference information of other UEs, and send the selected information in the DCI on the downlink control channel.

The base station may send the M sets of downlink reference information of other UEs sequentially (in a certain order).

When base stations serving the L other UEs include the base station under consideration and other base stations, the base station may first send information of other users served by the base station under consideration, and then send information of other users served by other base stations. The L other UEs may be the other UEs corresponding to the M sets of downlink reference information sent by the base station.

When cells serving the L other UEs include a present serving cell serving the UE and other cells other than the present serving cell, the base station may first send information of the other users served by the present serving cell, and then send information of the other users served by the other cells, The L other UEs may be the other UEs corresponding to the M sets of downlink reference information sent by the base station.

Here, a base station and a cell may belong to the LTE system.

When physical resources occupied by data sent by the base station to the UE overlap physical resources occupied by data sent to the other UEs by the base station under consideration or by other base stations, the data sent to the other users may interfere with the data to be demodulated by the UE. Data sent to some of the other users may interfere strongly, while data sent to the rest of the other users may interfere weakly. Information of those other users having strongly interfering downlink data is more important to interference suppression performance of the demodulation algorithm of the UE.

The base station may send the M sets of downlink reference information of the other users (also referred to as the other UEs) sequentially according to intensities of interference of information (data) of the other users to the UE.

The base station may first send information of the other users strongly interfering with the UE, and then send information of the other users interfering with the UE more weakly.

The UE may acquire data scheduling information from a downlink control channel and acquires N sets of downlink reference information of other UEs from DCI on a downlink control channel. The N is a positive integer less than a numerical value represented by a parameter of downlink data processing capability.

M sets of downlink reference information of the other UEs are sent by a base station. The M is a positive integer no less than the N.

The downlink control channel where the UE acquires the data scheduling information may be in a TTI identical to or different from a TTI including the downlink control channel where the UE acquires the DCI including the M sets of downlink reference information of the other UEs.

The UE may demodulate data sent to the UE by the base station according to the acquired information,

Each of the N sets of downlink reference information of the other UEs may include at least information on a user pilot.

The information on the user pilot may include at least a port of a downlink reference signal.

Each set of information of the other UEs acquired by the UE may be less than each set of information of the other UEs sent by the base station,

When demodulating the data sent to the UE by the base station, the UE may perform interference suppression according to the acquired information to improve data demodulation performance of the UE.

The UE may detect a data signal sent to the UE by the base station using an MMSE-IRC advanced detection algorithm according to the acquired information, and then send the detected data signal into a decoding module for decoding.

Alternatively, the UE may demodulate the data signal sent to the UE by the base station using another advanced receiving algorithm according to the acquired information.

The method according to an embodiment herein may be elaborated below with reference to an application scenario.

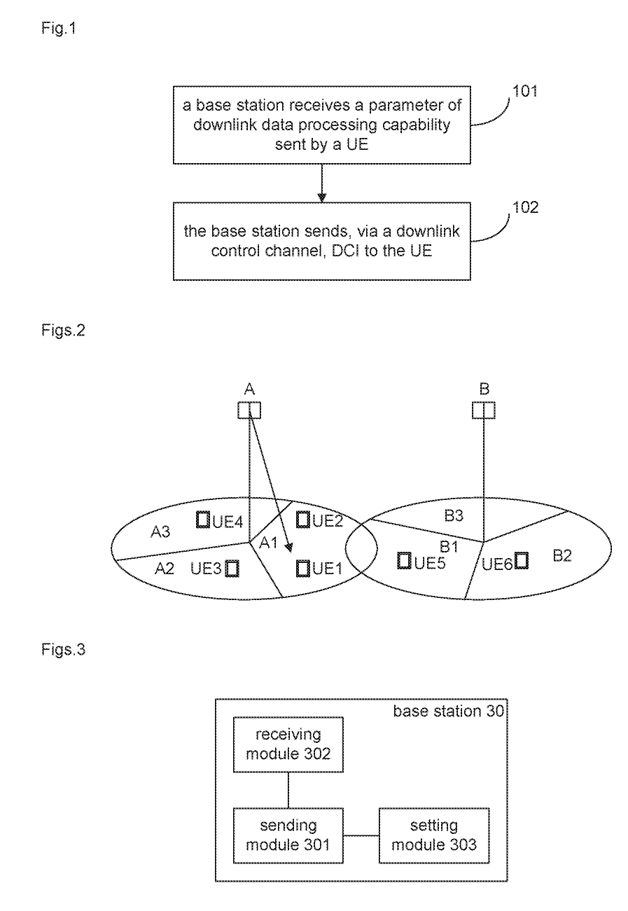

FIG. 2 is a diagram of interference of downlink data of other UEs according to an embodiment herein. In FIG. 2, a base station A may contain three cells A1, A2, and A3. A base station B may contain three cells B1, B2, and B3. UE1 and UE2 may be served by cell A1. UE3 may be served by cell A2. UE4 may be served by cell A3. UE5 may be served by cell B1. UE6 may be served by cell B2.

Assume that UE1 has 4 receiving antennae, and can process a maximal number of 4 layers of downlink data. Assume that a UE category of UE1 is a category 4, meaning that the UE1 can demodulate a maximal number of 2 layers of data.

Assume that the base station A sends a single layer of data to the UE1 on a physical time-frequency resource. Namely, the base station A sends a single layer of downlink data to the UE1 on a physical time-frequency resource in the cell A1

Further assume that the base station A sends in the cell A1, a single layer of data to the UE2 on the same physical time-frequency resource, the base station A sends in the cell A2, a single layer of data to the UE3 on the same physical time-frequency resource, the base station A sends in the cell A3, a single layer of data to the UE4 on the same physical time-frequency resource, the base station B sends in the cell B1, a single layer of data to the UE5 on the same physical time-frequency resource, and the base station B sends in the cell B2, a single layer of data to the UE6 on the same physical time-frequency resource. Thus, when demodulating downlink data sent thereto by the base station A, the UE1 may suffer from interference caused by downlink data of the other UEs of UE2 through UE6.

In order to suppress interference and improve demodulation performance, the UE1 may send a parameter of downlink data processing capability Q of the UE1 to the base station A. The parameter Q indicates that a maximal number of 4 layers of downlink data can be processed by the UE1. The Q may be set to 4 directly, Q=4. Alternatively, the Q may be set as a numerical value represented by the parameter of downlink data processing capability minus the maximal number of layers of data within demodulation capability of the UE as represented by the UE Category parameter of the UE, namely Q=4−2=2. Alternatively, a correspondence between the parameter Q and the maximal number of layers of downlink data within processing capability of the UE may be pre-set, and then may be set to a value corresponding to the maximal number of 4 layers of downlink data within processing capability of the UE1.

Since the UE1 can process a maximal number of 4 layers of downlink data, and the base station A sends a single layer of downlink data to the UE1, the UE1 can process a maximal number of 3 layers of other interfering data (4−1=3).

Assume that intensities of interference of the downlink data of the other UE2 through UE6 to the UE1 decreases in the order of UE5, UE2, UE3, UE4, and UE6. After receiving the sent by the UE1, the base station A may send three sets of downlink reference information of the UE2, the UE5 and the UE3 in DCI on a downlink control channel. Clearly, 3 is no greater than the maximal number of 4 layers of the downlink data within processing capability of the UE1.

Assume that the base station A allocates in the cell A1, a DMRS port AP1 to the UE2, and a Cell ID of the cell A1 is 101; the base station A allocates in the cell A2, a DMRS port AP2 to the UE3, and a Cell ID of the cell A2 is 102; and the base station B allocates in the cell B1, a DMRS port AP3 to the UE5, and a Cell ID of the cell B1 is ID3. The base station A may send in the cell A1 the three sets of downlink reference information ID3, AP3, AP1, ID2 and AP2 on the downlink control channel sequentially according to intensities of interference, or may send in the cell A1. the three sets of downlink reference information AP1, ID3, AP3, ID2 and AP2 sequentially by first sending information corresponding to the present serving cell A1 and then information corresponding to the other cells B1 and A2. As shown, in order to save downlink overhead information, the Cell ID of the cell A1 namely ID1, does not have to be sent. Of course, the Cell ID of the present serving cell A1 may as well be sent in order to facilitate sending by the base station and receiving by the UE.

A number of bits occupied by the three sets of downlink reference information sent in the downlink control channel by the base station A in the cell A1 may depend on 3, and may be computed according to the value 3. In this way, the base station A may pre-allocate physical time-frequency resources of a certain size for transmitting the three sets of downlink reference information. The base station A may send in the cell A1, only one or two sets of downlink reference information, or may send different sets of downlink reference information in different TTIs.

The base station A may set a value R via a system RRC according to the Q fed back by the UE1, such that the three sets of downlink reference information may take up no greater than R bits, If the three sets of downlink reference information take up more than R bits, the base station A may send in the cell A1, only one or two sets of downlink reference information.

The UE1 may acquire downlink data scheduling information from a downlink control channel in the cell A1, and acquire from a downlink control channel, the three sets of downlink reference information, or only one or two of the 3 sets of downlink reference information.

Each set of information of the other UEs acquired by the UE may be less than each set of information of the other UEs sent by the base station.

When demodulating the data sent to the UE by the base station, the UE may perform interference suppression according to the acquired information to improve data demodulation performance of the UE.

The UE may detect a data signal sent to the UE by the base station using an MMSE-IRC advanced detection algorithm according to the acquired information, and then send the detected data signal into a decoding module for decoding.

Alternatively, the UE may demodulate the data signal sent to the UE by the base station using another advanced receiving algorithm according to the acquired information.

As shown in FIG. 3, a base station 30 according to an embodiment herein includes a sending module 301 configured for: sending, via a downlink control channel, a User Equipment (UE) Downlink Control Information (DCI). The DCI includes X bits indicating M sets of downlink reference information of other UEs other than the UE.

The X is a positive integer. The M is a positive integer less than a numerical value represented by a parameter of downlink data processing capability of the UE.

Data of the other UEs may occupy physical resources overlapping physical resources occupied by data of the UE.

The X may meet at least one of the following descriptions.

The X may be computed according to the M.

The X may vary dynamically in different Transmission Time Intervals (TTI).

The X may be no greater than a value set by a system Radio Resource Control protocol (RRC).

The X may be no greater than a value set by the system RRC according to the parameter of downlink data processing capability.

The X may be no greater than a value corresponding to the parameter of downlink data processing capability.

The parameter of downlink data processing capability may meet at least one of the following descriptions.

The parameter of downlink data processing capability may be represented by a maximal number of layers of downlink data within processing capability of the UE.

The maximal number of layers of downlink data within processing capability of the UE may be no less than a maximal number of layers of data within demodulation capability of the UE as represented by a UE Category parameter of the UE.

The parameter of downlink data processing capability may be represented by a number of degrees of freedom within processing capability of the UE.

The parameter of downlink data processing capability may be represented by a number of receiving antennae of the UE.

The base station may further include a receiving module 302 configured for: after the base station has sent the UE a UE Capability Enquiry, receiving the parameter of downlink data processing capability sent by the UE.

The base station may further include a setting module 303 configured for: pre-setting a set containing parameters of downlink reference information of the other UEs, and selecting a sub-set of the set as the M sets of downlink reference information of the other UEs.

The sending module 301 may be configured for sequentially sending the M sets of downlink reference information of the other UEs.

The sending module 301 may be configured for: when cells serving L other UEs comprise a present serving cell serving the UE and other cells other than the present serving cell, first sending downlink reference information of the other UEs served by the present serving cell, and then sending downlink reference information of the other UEs served by the other cells.

The L may be a positive integer no greater than the M. The L other UEs may be the other UEs corresponding to the M sets of downlink reference information sent by the base station.

The sending module 301 may be configured for sequentially sending the M sets of downlink reference information of the other UEs according to intensities of interference of the other UEs to the UE.

In embodiments herein, the sending module 301, the receiving module 302, and the setting module 303 may be implemented by a Central Processing Unit (CPU), a Digital Signal Processor (DSP), or a Field-Programmable Gate Array (FPGA) in the base station 30.

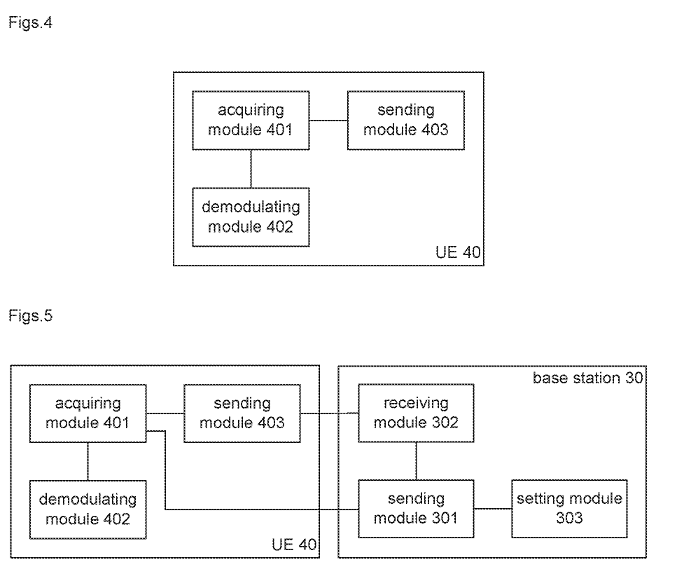

As shown in FIG. 4, a UE 40 according to an embodiment herein includes an acquiring module 401 configured for acquiring, from Downlink Control Information (DCI) on a downlink control channel, N sets of downlink reference information of other UEs other than the UE.

The N may be a positive integer less than a numerical value represented by a parameter of downlink data processing capability of the UE. M sets of downlink reference information of the other UEs may be sent by a base station. The M may be a positive integer no less than the N.

Data of the other UEs may occupy physical resources overlapping physical resources occupied by data of the UE.

The UE may further include a demodulating module 402 configured for demodulating, according to the downlink reference information of the other UEs acquired by the acquiring module and data scheduling information acquired from a downlink control channel, data sent by the base station.

The acquiring module 401 may be further configured for acquiring the data scheduling information from the downlink control channel.

The UE may further include a sending module 403 configured for: after the UE has received a UE Capability Enquiry sent by the base station, sending the parameter of downlink data processing capability to the base station.

The demodulating module 402 may be further configured for: when demodulating the data sent by the base station, performing interference suppression according to the acquired downlink reference information of the other UEs.

The demodulating module 402 may be further configured for: detecting, according to the acquired downlink reference information of the other UEs using a Minimum Mean Square Error-Interference Rejection Combining (MMSE-IRC) advanced detection algorithm, a data signal sent by the base station, and decoding the detected data signal.

The acquiring module 401, the demodulating module 402, and the sending module 403 may be implemented by a CPU, a DSP, or an FPGA in the UE 40.

As shown in FIG. 5, a system system for transmitting overhead information according to an embodiment herein includes the base station 30 and the UE 40.

According to embodiments herein, a base station slightly increases an overhead of a downlink control channel according to a parameter of downlink data processing capability fed back by a UE, such that demodulation performance of the UE may be improved. Since the UE is required to feed back the parameter of downlink data processing capability just now and then, an uplink overhead occupied by the parameter of downlink data processing capability is almost ignorable.

Those skilled in the art will know that an embodiment herein may be provided as a method, system, or computer program product. Therefore, an embodiment herein may take on a form of hardware, software, or a combination thereof. In addition, an embodiment herein may take on a form of a computer program product implemented on one or more computer available storage media (including but not limited to, magnetic disk memory, optic memory, and the like) containing computer available program codes.

The present disclosure is illustrated with reference to flowcharts and/or block diagrams of the method, device (system) and computer-program product according to embodiments described herein. Note that each flow in the flowcharts and/or each block in the block diagrams as well as combination of flows in the flowcharts and/or blocks in the block diagrams may be implemented by instructions of a computer program. Such instructions may be offered in a processor of a general-purpose computer, a dedicated computer, an embedded processor or other programmable data processing devices to generate a machine, such that a device with a function specified in one or more flows of the flowcharts and/or one or more blocks in the block diagrams is produced by instructions executed by a processor of a computer or other programmable data processing devices.

These computer-program instructions may also be stored in a non-transitory computer-readable memory capable of guiding a computer or another programmable data processing device to work in a given way, such that the instructions stored in the computer-readable memory generate a manufactured good including an instruction device for implementing a function specified in one or more flows of the flowcharts and/or one or more blocks in the block diagrams.

These computer-program instructions may also be loaded in a computer or other programmable data processing devices, which thus executes a series of operations thereon to generate computer-implemented processing, such that the instructions executed on the computer or other programmable data processing devices provide the steps for implementing the function specified in one or more flows of the flowcharts or one or more blocks in the block diagrams.

What described are merely embodiments of the present disclosure, and are not intended to limit the scope of the present disclosure.

1. A method for transmitting overhead information, comprising:
sending, by a base station via a downlink control channel, a User Equipment (UE) Downlink Control Information (DCI), the DCI comprising X bits indicating M sets of downlink reference information of other UEs other than the UE,
wherein the X is a positive integer, and the M is a positive integer less than a numerical value represented by a parameter of downlink data processing capability of the UE.

2. The method according to claim 1, wherein data of the other UEs occupy physical resources overlapping physical resources occupied by data of the UE.
wherein the X meets at least one of a first description through a fifth description, wherein
according to the first description the X is computed according to the M;
according to the second description, the X varies dynamically in different Transmission Time Intervals (TTI);
according to the third description, the X is no greater than a value set by a system Radio Resource Control protocol (RRC);
according to the fourth description, the X is no greater than a value set by the system RRC according to the parameter of downlink data processing capability; and
according to the fifth description, the X is no greater than a value corresponding to the parameter of downlink data processing capability,
wherein the parameter of downlink data processing capability meets at least one of a sixth description through an eighth description, wherein
according to the sixth description, the parameter of downlink data processing capability is represented by a maximal number of layers of downlink data within processing capability of the UE,
the maximal number of layers of downlink data within processing capability of the UE being no less than a maximal number of layers of data within demodulation capability of the UE as represented by a UE Category parameter of the UE;
according to the seventh description, the parameter of downlink data processing capability is represented by a number of degrees of freedom within processing capability of the UE; and
according to the eight description, the parameter of downlink data processing capability is represented by a number of receiving antennae of the UE.

3-4. (canceled)

5. The method according to claim 1, wherein the parameter of downlink data processing capability is set to the numerical value represented by the parameter of downlink data processing capability,
or wherein the parameter of downlink data processing capability is set to the numerical value represented by the parameter of downlink data processing capability minus a maximal number of layers of data within demodulation capability of the UE as represented by a UE Category parameter of the UE.

6. (canceled)

7. The method according to claim 1, further comprising:
after sending the UE a UE Capability Enquiry, receiving, by the base station, the parameter of downlink data processing capability sent by the UE,
wherein the DCI comprises an M indicating parameter, the M indicating the number of sets of downlink reference information to be sent by the base station,
wherein the DCI further comprises parameter indicating update of the downlink reference information of the other UEs.
wherein each of the M sets of downlink reference information of the other UEs comprises at least information on a user pilot,
wherein the information on the user pilot comprises at least a port of a downlink reference signal.

8-11. (canceled)

12. The method according to claim 1, wherein when U of the M sets of downlink reference information of the other UEs belong to the other UEs served by one of other cells other than a present serving cell serving the UE, information on a user pilot in at least one of the U sets of downlink reference information comprises at least information on a Cell ID of the one of the other cells where the information on the user pilot is sent, the U being a positive integer no greater than the M.

13. The method according to claim 1, further comprising:
pre-setting, by the base station, a set containing parameters of downlink reference information of the other UEs, and selecting a sub-set of the set as the M sets of downlink reference information of the other UEs,

14. The method according to claim 1, further comprising:
sequentially sending, by the base station, the M sets of downlink reference information of the other UEs;
or when cells serving L other UEs comprise a present serving cell serving the UE and other cells other than the present serving cell, first sending, by the base station, downlink reference information of the other UEs served by the present serving cell, and then sending downlink reference information of the other UEs served b the other cells,
wherein the Lisa positive integer no greater than the M, and the L other UEs are the other UEs corresponding to the M sets of downlink reference information sent by the base station;
or sequentially sending, by the base station, the M sets of downlink reference information of the other UEs according to intensities of interference of the other UEs to the UE.

15-16. (canceled)

17. A method for transmitting overhead information, comprising:
acquiring, by a User Equipment (UE) from Downlink Control Information (DCI) on a downlink control channel, N sets of downlink reference information of other UEs other than the UE,
wherein the N is a positive integer less than a numerical value represented by a parameter of downlink data processing capability of the UE, and M sets of downlink reference information of the other UEs are sent by a base station, the M being a positive integer no less than the N.

18. The method according to claim 17, wherein data of the other UEs occupy physical resources overlapping physical resources occupied by data of the UE,
wherein the method further comprises:
demodulating, by the UE according to the acquired downlink reference information of the other UEs and data scheduling information acquired from a downlink control channel, data sent by the base station;
when demodulating the data sent by the base station, performing, by the UE interference suppression according to the acquired downlink reference information of the other UEs.

19. (canceled)

20. The method according to claim 17, wherein the parameter of downlink data processing capability meets at least one of a sixth description through an eighth description, wherein
according to the sixth description, the parameter of downlink data processing capability is represented by a maximal number of layers of downlink data within processing capability of the UE,
the maximal number of layers of downlink data within processing capability of the UE being no less than a maximal number of layers of data within demodulation capability of the UE as represented by a UE Category parameter of the UE;
according to the seventh description, the parameter of downlink data processing capability is represented by a number of degrees of freedom within processing capability of the UE; and
according to the eighth description, the parameter of downlink data processing capability is represented by a number of receiving antennae of the UE.

21. The method according to claim 17, wherein the parameter of downlink data processing capability is set to the numerical value represented by the parameter of downlink data processing capability,
or wherein the parameter of downlink data processing capability is set to the numerical value represented by the parameter of downlink data processing capability minus a maximal number of layers of data within demodulation capability of the UE as represented by a UE Category parameter of he UE.

22. (canceled)

23. The method according to claim 17, further comprising:
after receiving a UE Capability Enquiry sent by the base station, sending, by the UE, the parameter of downlink data processing capability to the base station.

24. The method according to claim 17, wherein each of the N sets of downlink reference information of the other UEs comprises at least information on a user pilot,
wherein the information on the user pilot comprises at least a port of a downlink reference signal.

25-26. (canceled)

27. The method according to claim 17, further comprising:
detecting, by the UE according to the acquired downlink reference information of the other UEs using a Minimum Mean Square Error-Interference Rejection Combining (MMSE-IRC) advanced detection algorithm, a data signal sent by the base station, and decoding the detected data signal.

28. A base station, comprising a sending module configured for: sending, via a downlink control channel, a User Equipment (UE) Downlink Control Information (DCI), the DCI comprising X bits indicating M sets of downlink reference information of other UEs other than the UE,
wherein the X is a positive integer, and the M is a positive integer less than a numerical value represented by a parameter of downlink data processing capability of the UE.

29. The base station according to claim 28, wherein data of the other UEs occupy physical resources overlapping physical resources occupied by data of the UE,
wherein the X meets at least one of a first description through a fifth description, wherein
according to the first description, the X is computed according to the M;
according to the second description, the X varies dynamically in different Transmission Time Intervals (TTI);
according to the third description, the X is no greater than a value set by a system Radio Resource Control protocol (RRC);
according to the fourth description, the X is no greater than a value set by the system RRC according to the parameter of downlink data processing capability; and
according to the fifth description the X is no greater than a value corresponding to the parameter of downlink data processing capability,
wherein the parameter of downlink data processing capability meets at least one of a sixth description through an eighth description, wherein
according to the sixth description, the parameter of downlink data processing capability is represented by a maximal number of layers of downlink data within processing capability of the UE,
the maximal number of layers of downlink data within processing capability of the UE being no less than a maximal number of layers of data within demodulation capability of the UE as represented by a UE Category parameter of the UE;
according to the seventh description, the parameter of downlink data processing capability is represented by a number of degrees of freedom within processing capability of the UE; and
according to the eighth description, the parameter of downlink data processing capability is represented by a number of receiving antennae of the UE.

30-31. (canceled)

32. The base station according to claim 28, further comprising a receiving module configured for: after the base station has sent the UE a UE Capability Enquiry, receiving the parameter of downlink data processing capability sent by the UE.

33. The base station according to claim 28, further comprising a setting module configured for: pre-setting a set containing parameters of downlink reference information of the other UEs, and selecting a sub-set of the set as the M sets of downlink reference information of the other UEs.

34. The base station according to claim 28, wherein the sending module is configured for sequentially sending the M sets of downlink reference information of the other UEs,
or wherein the sending module is configured for: when cells serving L other UEs comprise a present serving cell serving the UE and other cells other than the present serving cell first sending downlink reference information of the other UEs served b the present serving cell and then sending downlink reference information of the other UEs served by the other cells,
wherein the L is a positive integer no greater than the M, and the L other UEs are the other UEs corresponding to the M sets of downlink reference information sent by the base station,
or wherein the sending module is configured for sequentially sending the M sets of downlink reference information of the other UEs according to intensities of interference of the other UEs to the UE.

35-36. (canceled)

37. A User Equipment (UE), comprising an acquiring module configured for acquiring, from Downlink Control Information (DCI) on a downlink control channel, N sets of downlink reference information of other UEs other than the UE,
wherein the N is a positive integer less than a numerical value represented by a parameter of downlink data processing capability of the UE, and M sets of downlink reference information of the other UEs are sent by a base station, the M being a positive integer no less than the N.

38. The UE according to claim 37, wherein data of the other UEs occupy physical resources overlapping physical resources occupied by data of the UE,
wherein the UE further comprises a demodulating module configured for demodulating, according to the downlink reference information of the other UEs acquired by the acquiring module and data scheduling information acquired from a downlink control channel, data sent by the base station, wherein
the acquiring module is further configured for acquiring the data scheduling information from the downlink control channel,
wherein the demodulating module is further configured for: when demodulating the data sent by the base station, performing interference suppression according to the acquired downlink reference information of the other UEs.

39. (canceled)

40. The UE according to claim 37, further comprising a sending module configured for: after the UE has received a UE Capability Enquiry sent by the base station, sending the parameter of downlink data processing capability to the base station.

41. (canceled)

42. The UE according to claim 37, wherein the demodulating module is further configured for: detecting, according to the acquired downlink reference information of the other UEs using a Minimum Mean Square Error-Interference Rejection Combining (MMSE-IRC) advanced detection algorithm, a data signal sent by the base station, and decoding the detected data signal.

43. (canceled)
